(19) United States
(12) Patent Application Publication
(10) Pub. No.: US 2003/0045150 A1
(43) Pub. Date: Mar. 6, 2003

(54) Socket for a contamination-protected plug connection as well as plug connection

(75) Inventor: Jens Krause, Rahden (DE)

Correspondence Address: Norman P. Soloway, HAYES SOLOWAY, P.C., 130 W. Cushing Street, Tucson, AZ, 85701, US

(73) Assignee: HARTING Automotive GmbH & Co. KG.

(21) Appl. No.: 10/222,442

(22) Filed: Aug. 16, 2002

(30) Foreign Application Priority Data
Aug. 29, 2001 (DE) 101 42 196.6

(51) Int. Cl. H01R 13/52

(52) U.S. Cl. 439/271

(57) ABSTRACT

A socket for a plug connection comprises a socket housing that has a contact chamber in which a plurality of socket contacts is arranged, a protective seal being provided which can be moved between a covering position in which it closes the contact chamber so as to be essentially flush towards outside, and a contact position in which the socket contacts are able to be accessed, the protective seal being able to be transferred from the covering position into the contact position by means of a complementary plug. There is further proposed a plug connection including such socket and a plug.

### TECHNICAL FIELD

The invention relates to a socket for a plug connection, comprising a socket housing that has a contact chamber in which a plurality of socket contacts is arranged.

### BACKGROUND OF THE INVENTION

Such a socket is known from DE 198 09 801 A1. The plug connection formed by such socket together with a complementary plug is suitable for being employed, in particular, in motor vehicles e.g. in the region of the doors or the bottom. In order to prevent any ingress of contamination into the socket, there is provided a plunger which is shiftably mounted inside the housing and closes the contact chamber of the socket in case the plug is not plugged in.

The invention is based on the object to further develop a socket of the type initially mentioned in that an improved protection against the ingress of contaminations is ensured, so that the plug connection can also be used in the bottom region of the motor vehicle, which is particularly exposed to contaminations.

### BRIEF SUMMARY OF THE INVENTION

According to the invention, a socket for a plug connection comprises a socket housing that has a contact chamber in which a plurality of socket contacts is arranged, a protective seal being provided which can be moved between a covering position in which it closes the contact chamber so as to be essentially flush towards outside, and a contact position in which the socket contacts are able to be accessed, the protective seal being able to be transferred from the covering position into the contact position by means of a complementary plug. The protective seal reliably prevents any ingress of contaminations into the contact chamber, whilst at the same time a simple and safe connection between the plug and the socket is made possible. Prospective contaminations do not accumulate over the contact chamber, because the protective seal covers the outer side of the contact chamber so as to be flush with it. Moreover, prospective contaminations can easily be removed.

In a preferred embodiment, the protective seal rests at the edge of the opening of the contact chamber, the edge being configured skewed. This results in an automatic centering of the protective seal to its optimum position. In addition, the pressure that is exerted on the protective seal from outside causes the protective seal to come to rest at the skewed edge more firmly, which automatically improves the sealing effect.

In case the protective seal consists of an elastic material, then a particularly good sealing function is achieved, because the protective seal can have a snug fit with the opening of the contact chamber.

It is particularly of advantage if the protective seal is mounted to a plunger that is shiftably mounted in the socket housing. In this way it is ensured that the protective seal together with the plunger can be pushed into the socket when the plug is inserted into the socket. In so doing, the socket contacts are freed only so far as the plug is inserted into the socket housing. Hence, the sealing function will be maintained for that part of the socket housing that is not yet applied by the plug.

The plunger is preferably provided with a surrounding groove that is engaged by a sealing skirt formed on the protective seal. It is in this way that the elastic protective seal can be fixed to the plunger with minimum expenditure.

According to the preferred embodiment it is provided for that the plunger is provided with a deepening on its end face facing the plug, that the protective seal extends across the end face of the plunger and projects towards outside beyond the side surfaces of the plunger in the covering position, and in that the protective seal comes to rest at the side surfaces of the plunger if it is pressed into the deepening by the plug, so that the plunger can be pushed into the contact chamber without the protective seal touching the socket contacts. Upon inserting the plug, the protective seal will thus automatically retract into its contact position, so that the plug can be lowered into the contact chamber without the protective seal rubbing against the edge of the contact chamber and without contaminations—that could adhere to the protective seal—being taken off and possibly getting in this way into the contact chamber.

It can be further provided for that the socket contacts are receded with respect to that edge of the socket housing which faces the plug. Thereby it is ensured that the socket contacts can not be contaminated by contaminations which possibly adhere to the protective seal.

In the plug connection according to the invention, there is provided a plug including a plug housing in which a plurality of plug contacts is arranged, it being provided that a protective shield mounted to the plug is movable between a covering position in which it covers the plug contacts, and a contact position in which the plug contacts are able to be accessed, the protective shield being able to be transferred from the covering position into the contact position during inserting into the socket. A mechanical damage or a contamination is prevented by the protective shield. This is of importance if the plug, for instance, is mounted to a vehicle seat which can be removed from the vehicle. The protective shield prevents the plug contacts from being deformed or damaged in any other way during the handling of the removed vehicle seat, because that could prevent a reliable contacting of the socket mounted to the vehicle bottom when the seat has been installed again.

It is a particularly advantageous arrangement if the plug comprises a plug-in section at which the plug contacts are exposed and which can be plugged into the socket, and if the protective shield surrounds the plug-in section on all sides. This is furthermore particularly of advantage if the protective shield comprises a skirt at its end associated to the front end of the plug-in section, by means of which skirt the plug contacts are forced inwards during inserting into the socket, so that they do not touch the edge of the contact chamber of the socket. Thereby it is prevented that any contaminations present at the edge of the contact chamber of the socket are taken up by the plug contacts and are introduced into the contact chamber.

### BRIEF DESCRIPTION OF THE DRAWINGS

FIG. 1 shows an exploded view of the plug;

FIG. 2 shows an exploded view of the socket;

FIG. 3 shows a cross-sectional view through the plug of FIG. 1;

FIG. 4 shows a cross-sectional view through the socket of FIG. 2;

FIG. 5 shows a perspective sectional view of the plug of FIG. 1;

FIG. 6 shows a perspective sectional view of the socket of FIG. 2;

FIG. 7 shows a cross-sectional view corresponding to FIGS. 3 and 4, with the plug plugged into the socket;

FIG. 8 shows a perspective sectional view corresponding to FIGS. 6 and 7, with the plug plugged into the socket; and

FIG. 9 shows a further perspective sectional view of plug and socket in the state plugged into each other.

### DETAILED DESCRIPTION OF THE PREFERRED EMBODIMENT

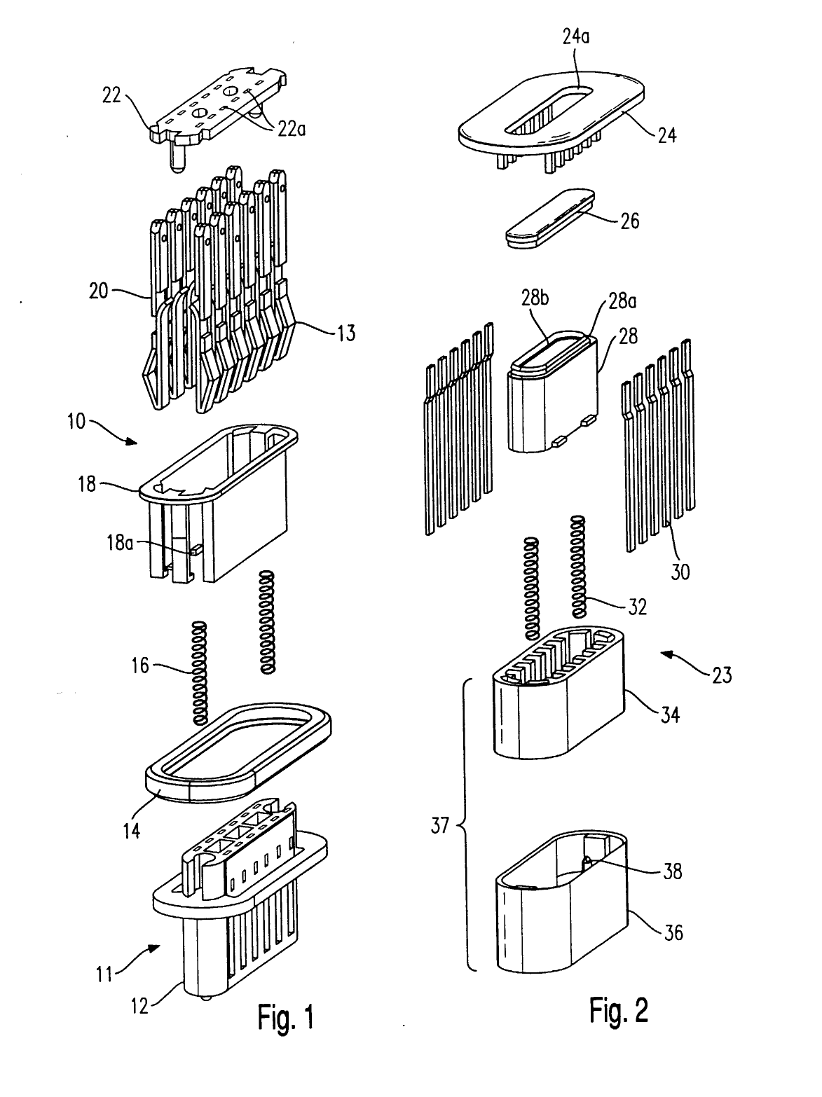

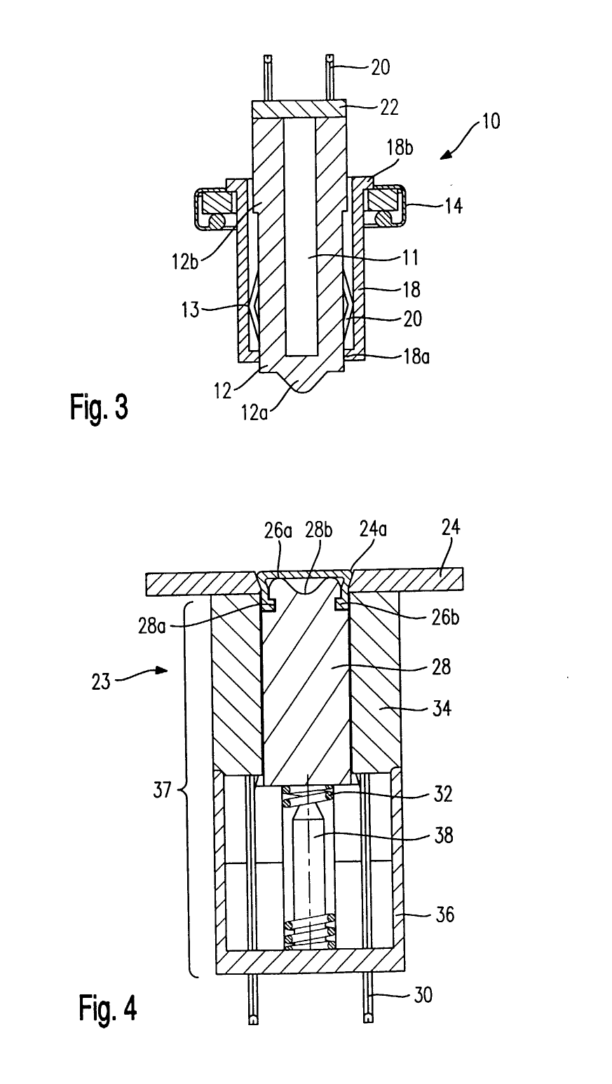

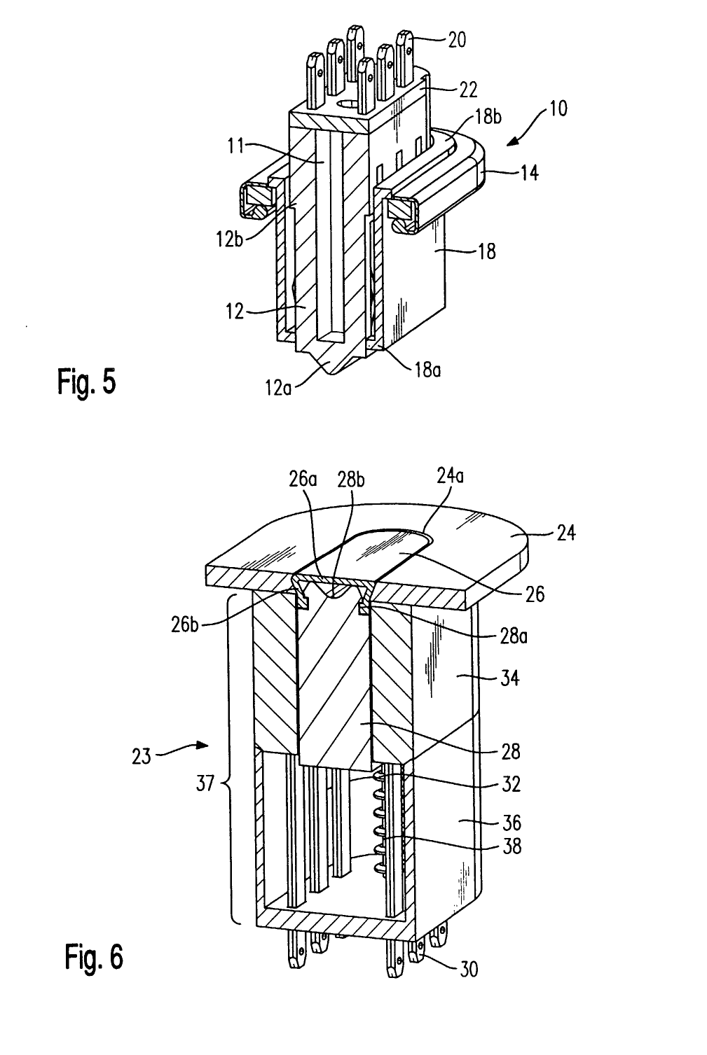

In FIGS. 1, 3 and 5 there is shown a plug 10 which comprises a plug housing 11 including a plug-in section 12, a plug flange 14, two plug springs 16, a protective shield 18 including a skirt 18a, plug contacts 20 and a plug cover 22 including contact cut-outs 22a.

The plug-in section 12 of the plug housing 11 is configured like a piston and is provided with a protrusion 12a at its front end as seen in the plug-in direction. The plug contacts are arranged in receptacles in the plug housing 11 so as to be unsupported, they being bent and configured with an apex 13. The plug contacts 20 come out of the plug through the contact cut-outs 22a of the plug cover 22 with respect to the Figures in upward direction, so that they can be connected to cables. The plug cover 22 closes the plug-in section 12 towards the top.

The protective shield 18 is shiftably mounted to the plug housing 11 and is shown in FIGS. 1, 3 and 5 in the covering position. The covering position is defined in that a shield flange 18b of the protective shield 18 rests at the plug flange 14 of the plug housing 11. In the covering position, the exposed region of the plug contacts in the plug-in section 12 is covered, so that the plug contacts are protected from mechanical damage and from contamination, too. Here, the skirt 18a rests at the plug-in section 12 with a tight fit. The protective shield 18 can be brought from the covering position against the action of the plug springs 16 and contrary to the plug-in direction of the plug into the socket, i.e. upwards with respect to the Figures, into a contact position in which the plug contacts 20 are exposed in the region of the plug-in section 12.

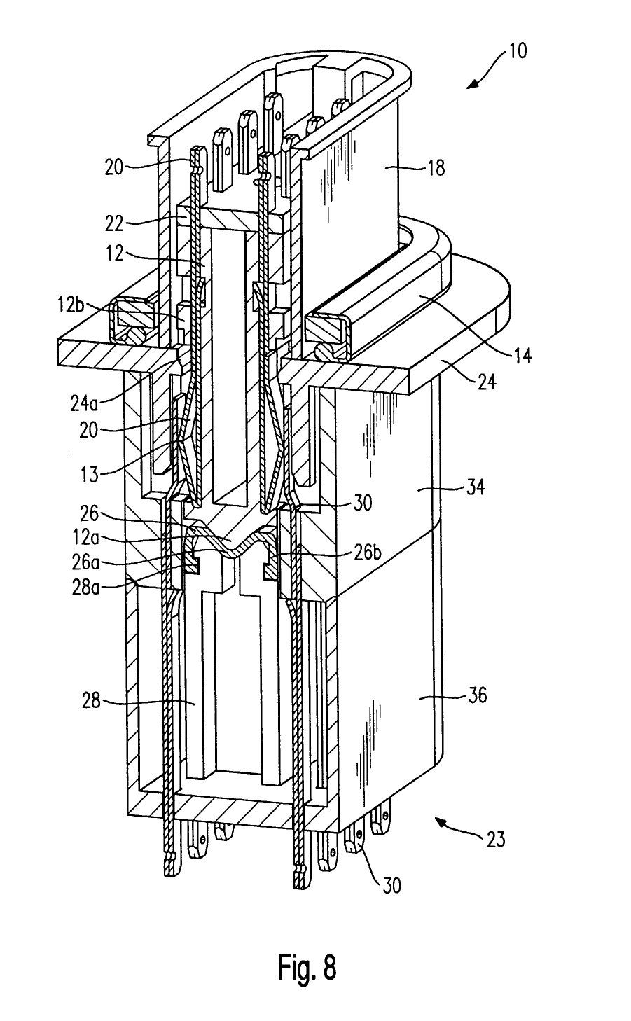

In FIGS. 2, 4 and 6 there is shown a socket 23 into which the plug 10 can be plugged. The socket 23 has a housing which is formed by a socket flange 24 as well as first and second contact chamber sections 34, 36. The two contact chamber sections 34, 36 form a contact chamber 37 in which a plurality of socket contacts 30 as well as a plunger 28 are arranged. The opening to the contact chamber is formed by an edge 24a in the socket flange 24. The socket contacts 30 are configured such that their end sections located in the vicinity of the socket flange 24 are receded towards outside with respect to the edge 24a of the socket flange (see FIG. 8). The socket contacts 30 project out of the contact chamber at the lower end of the second contact chamber section 36 with respect to the Figures, so that a cable can be connected.

At its end associated to the edge 24a, the plunger 28 has a surrounding groove 28a as well as a deepening 28b, the transition from the end face of the plunger to the groove 28a being configured skewed. A protective seal 26 extends across the deepening and has a middle section 26a as well as a surrounding sealing skirt 26b which engages the groove 28a, so that the protective seal is held on the front end of the plunger. In the position shown in FIGS. 2, 4 and 6, the protective seal 26 is in its sealing position in which the middle section 26a is flat and it tightly rests at the edge 24a of the socket. As seen from the outside of the socket, the protective seal 26 has the same shape as the opening to the contact chamber 37. In the relaxed state, the protective seal 26 has slightly larger dimensions than the opening in the socket flange 24, so that the protective seal rests at the edge 24a in a biased fashion.

Arranged in the contact chamber are two socket springs 32 on one spring guide element 38 each. The socket springs urge the plunger 28 into the position shown in FIGS. 2, 4 and 6, in which the protective seal 26 rests at the skewed edge 24a of the contact chamber 37. In this arrangement, the protective seal 26 terminates flush with the socket flange 24 towards outside. Thus, in the covering position which is shown here, the contact chamber 37 is closed against external influences such as dirt and wetness.

The operation of plugging the plug 10 into the socket 23 will be described in detail in the following. When the plug 10 is placed on the socket 23, first the protrusion 12a is pressed against the protective seal 26. Thereby, the protective seal is forced into the deepening 28b on the end face of the plunger 28 until it rests at the bottom thereof. In so doing, the middle section 26a of the protective seal 26 “shortens”, so that its outer edge retracts from the edge 24a of the socket flange 24 and is pulled towards the skew of the plunger between the end face thereof and the groove 28a. If the protective seal 26 is in this contact position, the plunger 28 can be pushed into the contact chamber 37 without the protective seal touching the edge 24a of the socket flange 24. In this way it is prevented that contaminations which are possibly present on the outside of the socket 23 or the protective seal 26 are transferred to the socket contacts 30. In addition, contaminations are not transferred to the socket contacts either, because these are receded.

During inserting the plug-in section 12 into the opening of the socket flange 24 or into the first contact chamber section 34, the plunger 28 is pushed further down against the spring force of the socket springs 32. As the protective shield 18 rests at the outer side of the socket flange 24, it is pushed back in the process, so that the plug contacts 20 are gradually exposed and are pushed into the contact chamber 37. In so doing, they are not exposed at any point in time, so that they are always protected from external influences during the entire plug-in operation. During the plug-in operation, the skirt 18a forces the bent plug contacts 30 towards inside into the plug-in section 12 when it slips over the apex 13, so that the plug contacts enter into the contact chamber 37 of the socket without touching the edge 24a.

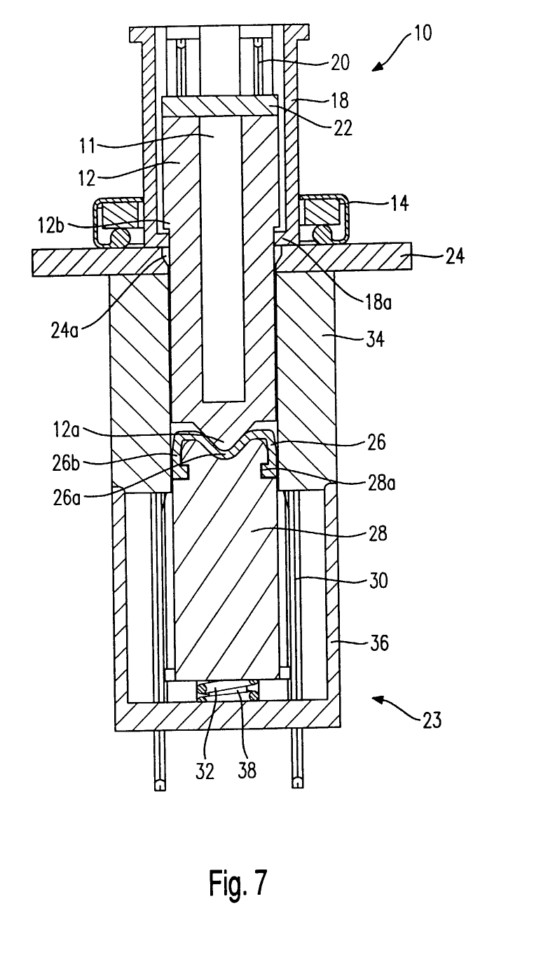

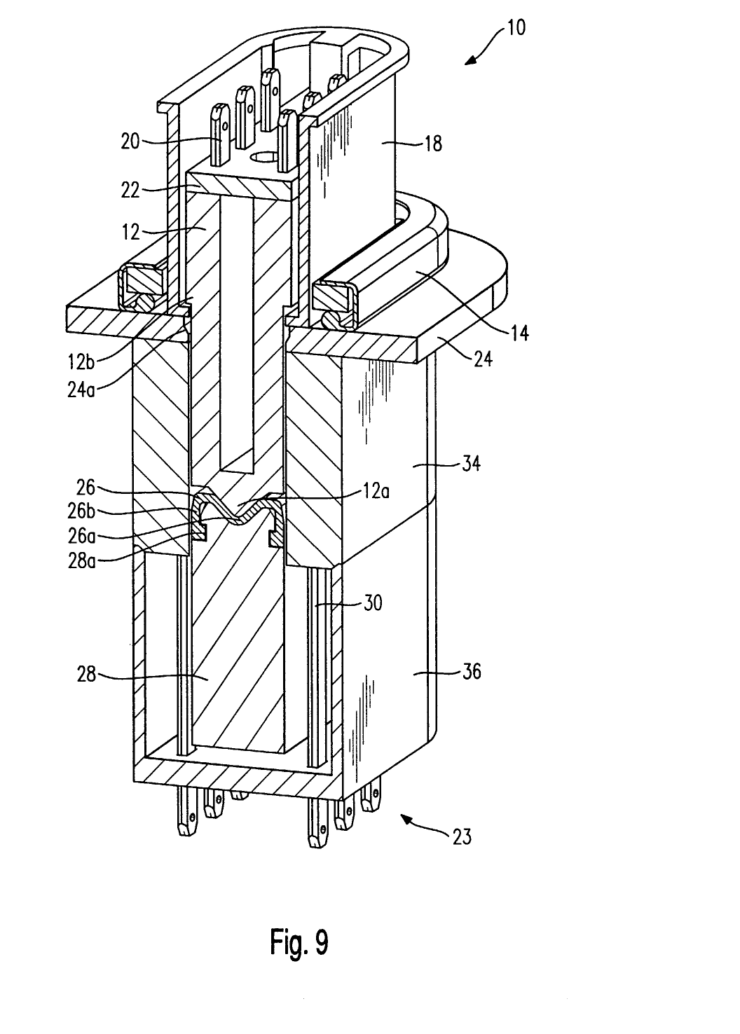

Now, the plug-in section 12 can be pushed into the first contact chamber section 34 as far as until a projection 12b of the plug housing 11 rests at the skirt 18a and the plug flange 14 tightly rests on the socket flange 24, whereby a good sealing effect is ensured (see FIGS. 7, 8 and 9). In this process, the protective shield 18 is completely pushed back to the contact position. The plug-in section 12, the plug contacts 20 and the socket contacts 30 are dimensioned such that the plug contacts make full electrical contact with the socket contacts at the end of the plug-in procedure. It is achieved in particular by the engagement of the protrusion 12a in the deepening 28b that the plug-in section 12 is centered; with this, the plug contacts 20 and the socket contacts 30 have good contact with each other both on the left and right hand-side with respect to the Figures.

When the plug 10 including the plug-in section 12 is retracted from the first contact chamber section 34 of the socket 23, there will be maintained at any time, due to the spring force of the socket springs 32, a tight contact between the plug-in section and the plunger 28 in the region of the protrusion 12a and the deepening 28b. At the same time the protective shield 18 continues to rest at the socket flange 24. When the plug 10 is completely pulled out of the socket 23, the protective shield 18 returns to its covering position in which the plug contacts 20 are protected from external influences. At the same time the protective seal 26 returns to its covering position in which it tightly rests at the edge 24a of the socket flange 24 and closes the contact chamber 37 of the socket.

1. A socket for a plug connection, said socket comprising a socket housing that has a contact chamber in which a plurality of socket contacts is arranged, a protective seal being provided which can be moved between a covering position in which it closes said contact chamber so as to be essentially flush towards outside, and a contact position in which said socket contacts are able to be accessed, said protective seal being able to be transferred from said covering position into said contact position by means of a complementary plug.

2. The socket according to claim 1, wherein said protective seal rests at an edge of an opening of said contact chamber, said edge being configured skewed.

3. The socket according to claim 1, wherein said protective seal consists of an elastic material.

4. The socket according to claim 1, wherein said protective seal is mounted to a plunger that is shiftably mounted in said socket housing.

5. The socket according to claim 4, wherein said plunger is provided with a surrounding groove that is engaged by a sealing skirt formed on said protective seal.

6. The socket according to claim 4, wherein said plunger is provided with a deepening on its end face facing said plug, said protective seal extending across said end face of said plunger and projecting towards outside beyond side surfaces of said plunger in said covering position, and wherein said protective seal comes to rest at side surfaces of said plunger if it is pressed into said deepening by said plug, so that said plunger can be pushed into said contact chamber without said protective seal touching said socket contacts.

7. The socket according to claim 1, wherein said socket contacts are receded with respect to that edge of said socket housing which faces said plug.

8. A plug connection comprising a socket including a socket housing that has a contact chamber in which a plurality of socket contacts is arranged, a protective seal being provided which can be moved from a covering position in which it closes said contact chamber so as to be essentially flush towards outside, and a contact position in which said socket contacts are able to be accessed, said protective seal being able to be transferred from said covering position into said contact position by means of a complementary plug, said plug connection further comprising a plug including a plug housing in which a plurality of plug contacts is arranged, a protective shield mounted to said plug being movable between a covering position in which it covers said plug contacts, and a contact position in which said plug contacts are able to be accessed, said protective shield being able to be transferred from said covering position into said contact position during inserting into said socket.

9. The plug connection according to claim 8, wherein said plug comprises a plug-in section at which said plug contacts are exposed and which can be plugged into said socket, and wherein said protective shield surrounds said plug-in section on all sides.

10. The plug connection according to claim 9, wherein said protective shield comprises a skirt at its end associated to a front end of said plug-in section, by means of which skirt said plug contacts are forced inwards during inserting into said socket, so that they do not touch said edge of said contact chamber of said socket.
